(19) United States
(12) Patent Application Publication
(10) Pub. No.: US 2014/0204328 A1
(43) Pub. Date: Jul. 24, 2014

(54) LIQUID CRYSTAL DISPLAY DEVICE

(71) Applicant: Takaharu Kikuchi, Osaka-shi (JP)

(72) Inventor: Takaharu Kikuchi, Osaka-shi (JP)

(73) Assignee: SHARP KABUSHIKI KAISHA, Osaka-shi ,Osaka (JP)

(21) Appl. No.: 14/117,267

(22) PCT Filed: Apr. 2, 2012
(86) PCT No.: PCT/JP2012/058856

§ 371 Date: Nov. 12, 2013

(30) Foreign Application Priority Data
May 13, 2011 (JP) 2011-107757

(51) Int. Cl. G02F 1/1333

(52) U.S. Cl. CPC G02F 1/133382
USPC 349/161

(57) ABSTRACT

The objective is to provide technology reducing effect on battery performance by heat release source, even if many electronic components are arranged densely. In this liquid crystal display device, a battery (70) configured from nine cells (71) is attached to a battery arranging face (73) of backlight chassis (60). A hole (72) is formed at the entire battery arranging face (73). A light source is attached to rear face bottom of backlight chassis (60). Heat of light source is transferred by the backlight chassis (60) and transmitted to the battery (70) attached to the battery arranging face (73). However, as the hole (72) is formed at the entire battery arranging face (73), heat transmitted by the backlight chassis (60) is insulated by the hole (72) at the entire battery arranging face (73) and difficult to be transmitted to the battery (70), thus making it possible to prevent cell (71) deterioration.

### TECHNICAL FIELD

The present invention relates to a liquid crystal display device and, in particular, to a portable liquid crystal display device which has a battery.

### BACKGROUND ART

Conventionally, a battery is frequently used as a power source of portable electronic equipment. In general, the battery is configured from a plurality of chargeable cells. Since the cell is liable to be deteriorated in a high-temperature environment, the cell positioned near a heat release source is more likely to be deteriorating and run out the remaining amount than other cells. Since the cells could undergo damage or the like when being subjected to over discharge, at the time when the remaining amount of any cell runs out, it is necessary to stop discharge even if other cell has the remaining amount. When the cells are charged in this state, balance of the remaining amount between the cells is lost, so that a difference is caused in timing of being fully charged between the cells. Since the cell could undergo damage or the like by over discharge, at the time when any cell becomes fully charged, it is necessary to stop charging of other cell. As a result, the charging balance between the cells is further lost and performance of the entire battery is deteriorated.

Therefore, for example, portable electronic equipment has been known that a heat-insulating space is provided by arranging a CPU and a battery adjacent to the CPU separately to reduce the effect that heat from the CPU which is a heat release source imposes on battery performance (for example, refer to Patent Literature 1).

### CITATION LIST

### Patent Literature

PATENT LITERATURE 1: Japanese Laid-Open Patent Publication No. 2007-122132

### SUMMARY OF INVENTION

### Technical Problem

However, recent electronic equipment has a problem that along with an increase in functionality and a reduction in size, many electronic components are arranged densely in the electronic equipment and a space for the heat-insulating space like in Patent Literature 1 is difficult to be secured.

The present invention has been made in view of the above-described problem, and aims to provide a technology which is capable of reducing the effect that a heat release source imposes on battery performance, even if many electronic components are arranged densely.

### Solution to Problem

A liquid crystal display device of the present invention comprises a backlight chassis to which a light source is attached, a battery arranging face provided on a face opposite to a face to which the light source of the backlight chassis is attached, a hole formed at the battery arranging face, and a battery attached to the battery arranging face. Moreover, the hole may be formed corresponding to a cell constituting the battery. Moreover, the hole may be formed larger as a distance from the light source is closer. Moreover, the hole may have a shape that enables to adjust an opening area. Moreover, the battery may be covered with a black package and attached in close contact to the battery arranging face.

### Advantageous Effects of Invention

According to the present invention, it is possible to reduce the effect that a heat release source imposes on battery performance, even if many electronic components are arranged densely.

### BRIEF DESCRIPTION OF DRAWINGS

FIG. 1 are plan views and a side view showing an appearance of a liquid crystal television according to an embodiment of the present invention.

FIG. 2 is an exploded perspective view showing an appearance of the liquid crystal television shown in FIG. 1.

FIG. 3 are a front view and a perspective view of a backlight chassis shown in FIG. 2.

FIG. 4 is a simplified side view of the backlight chassis shown in FIG. 2.

FIG. 5 are a front view and a perspective view of the backlight chassis of other embodiment shown in FIG. 2.

### DESCRIPTION OF EMBODIMENTS

Description will hereinafter be given specifically for an embodiment of the present invention with reference to drawings. In the present embodiment, description will be given for a liquid crystal television 10 as an example of a liquid crystal display device.

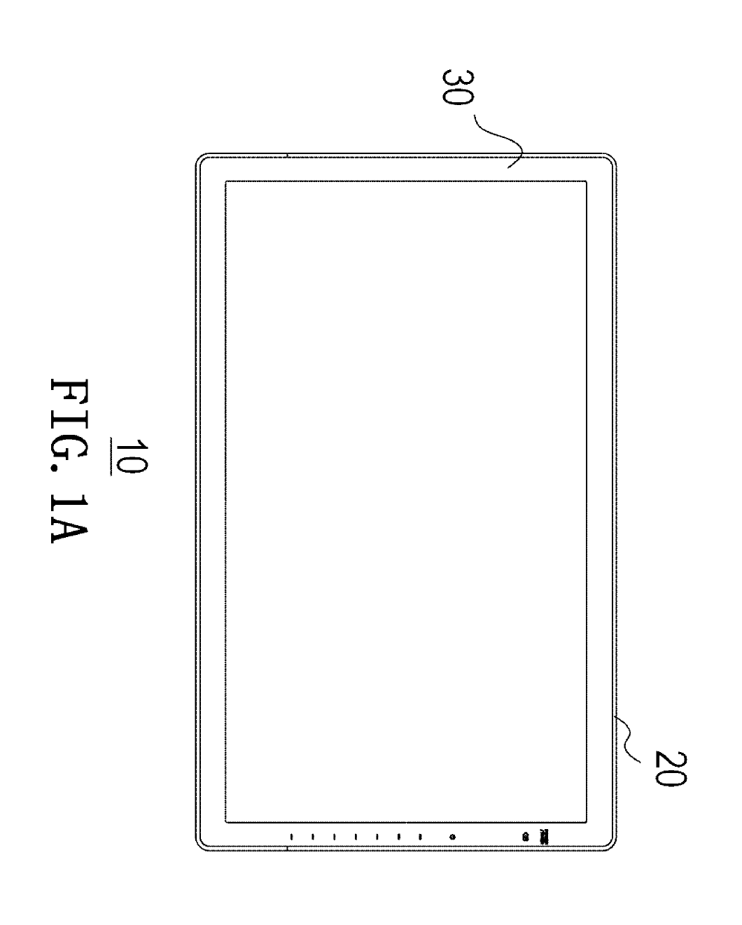

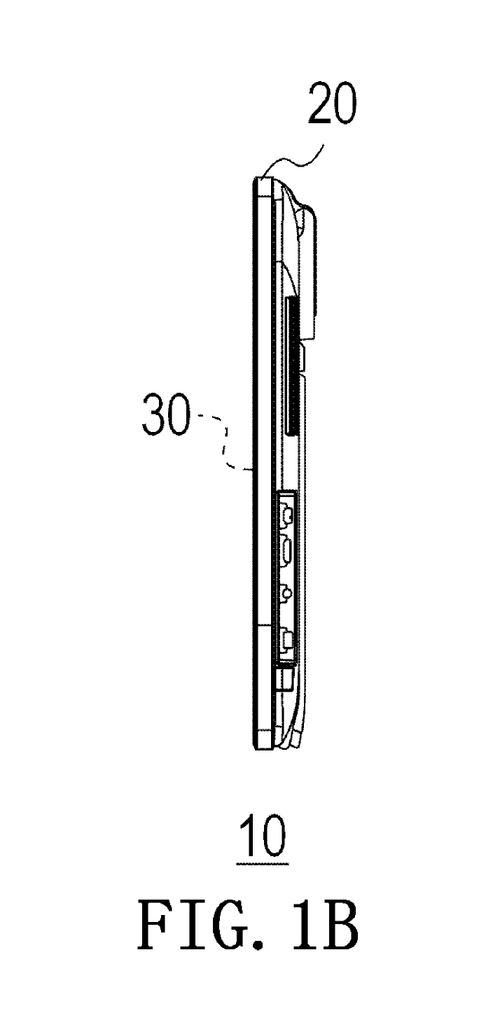

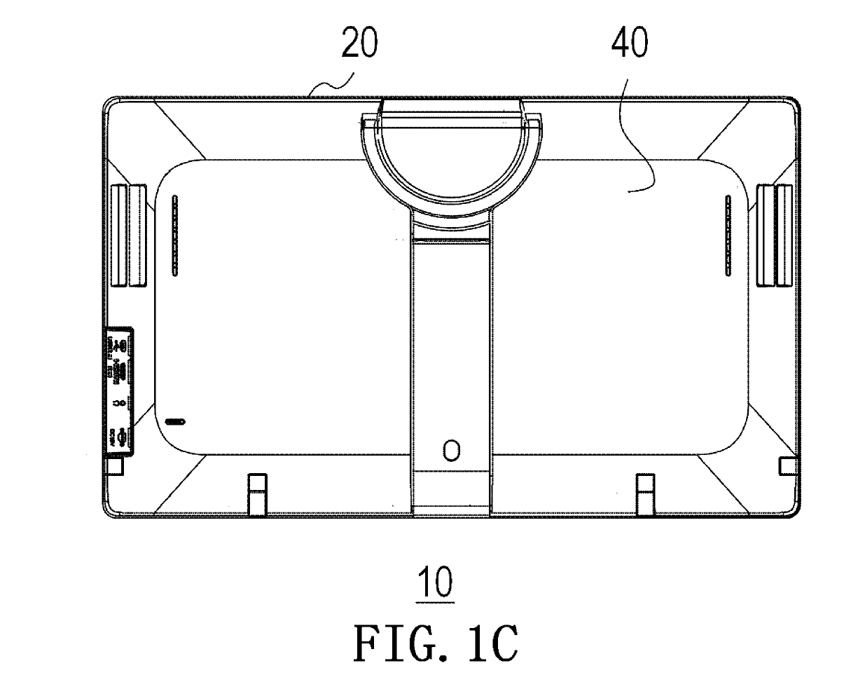

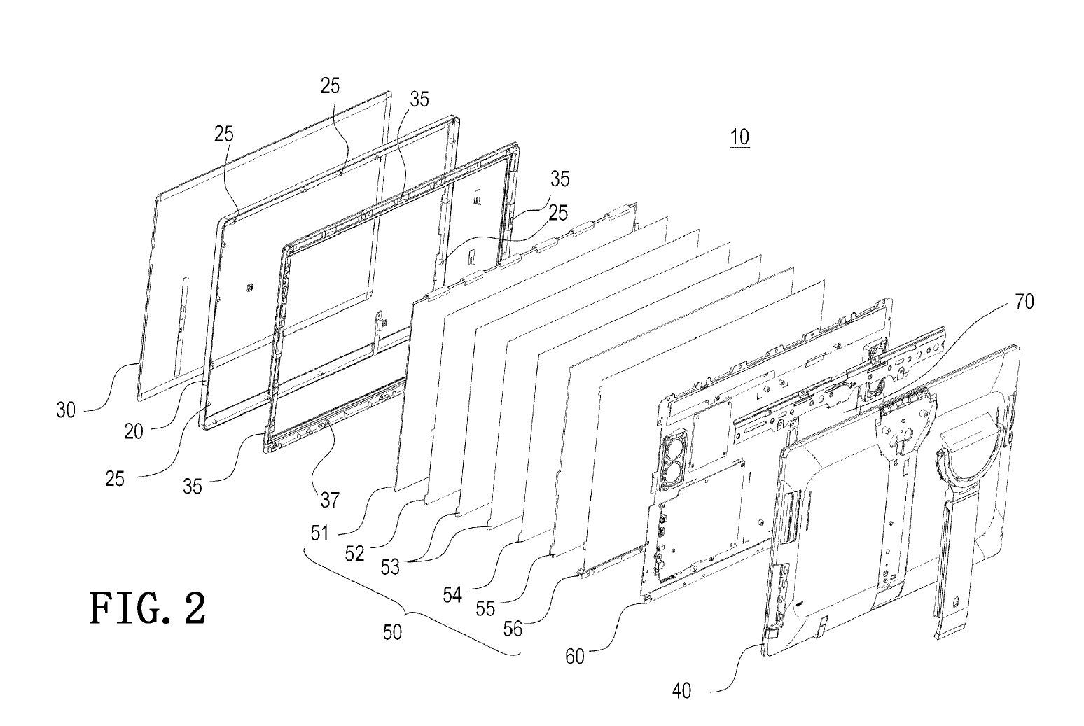

FIG. 1 are views showing an appearance of the liquid crystal television 10 according to the present embodiment. Moreover, FIG. 2 is an exploded perspective view of the liquid crystal television 10. The liquid crystal television 10 is provided with as an exterior a frame-shaped frame 20 which is an exterior side face cabinet, a transparent protection cover 30 on the front side, and a rear cabinet 40 on the rear side. In addition, inside the exteriors, a front cabinet frame 35, a sheet group 50 and a backlight chassis 60 are arranged from the side of the transparent protection cover 30.

The frame 20 is a molded component by a metallic processing member (by processing extruded material or drawing material). For example, in the case of a 20-inch class, a rough size is about 490 mm width×about 290 mm height.

The transparent protection cover 30 is, for example, a glass plate and protects the sheet group 50. The rear cabinet 40 is molded with resin material.

The front cabinet frame 35 is molded with resin material to have the substantially same size and shape with the frame 20, and is attached to the rear face side of the frame 20. Note that, in the frame 20, a cylindrical positioning projection portion 25 is formed at a predetermined position to extend in a back direction. On the front face side of the front cabinet frame 35, a positioning boss hole 37 is provided corresponding to the positioning projection portion 25.

The sheet group 50 has a liquid crystal panel 51, a Df sheet 52, a lens sheet 53, a light guide plate 54, a diffusion sheet 55, and a reflection plate 56 arranged in a laminated form from the front side.

The backlight chassis 60 is such that a metallic plate-shaped body is processed to have a predetermined shape, in which a light source (for example, an LED edge light), a video image driving circuit, a battery 70 and the like are arranged.

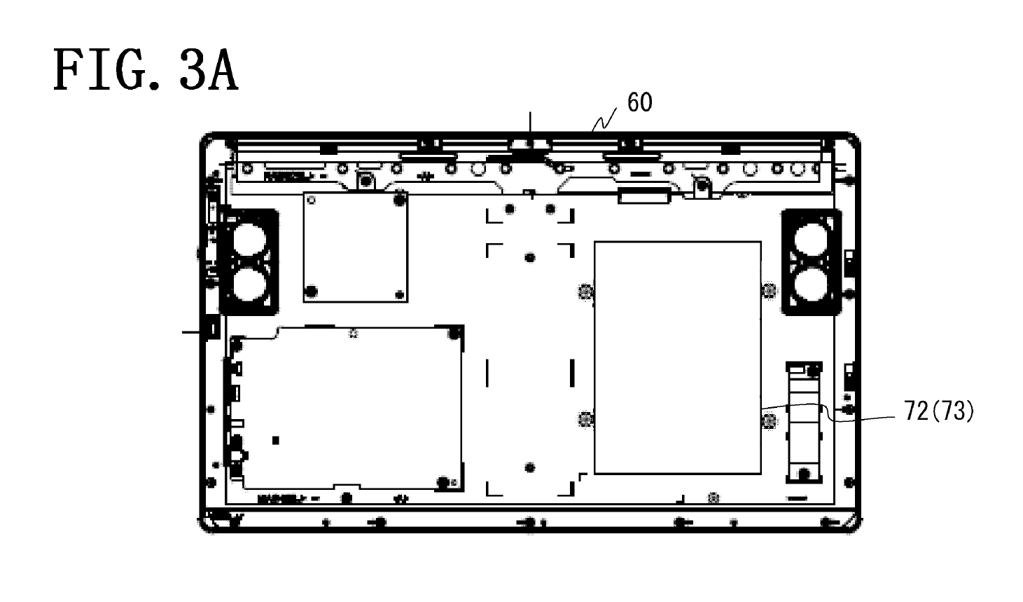

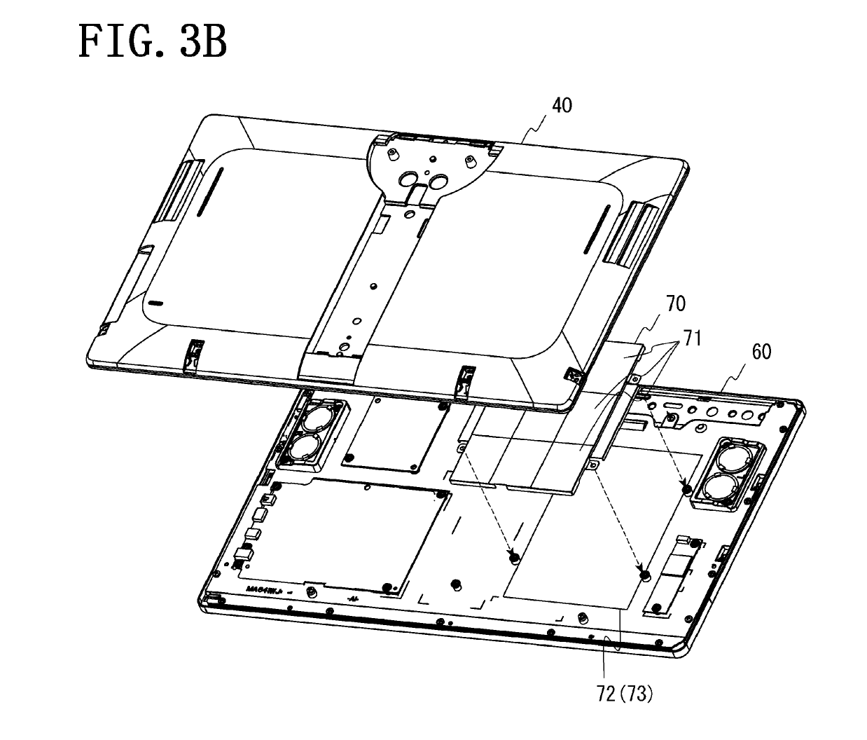

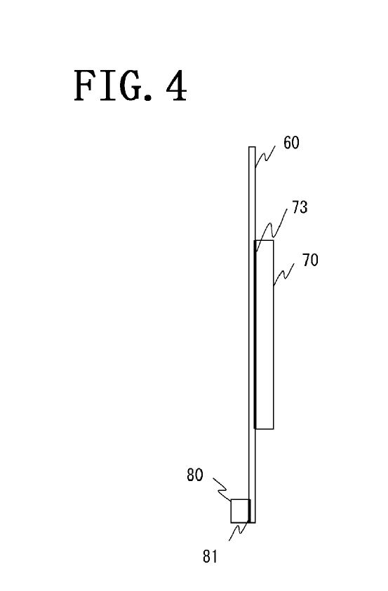

FIG. 3(a) is a front view of the backlight chassis 60 and FIG. 3(b) is a perspective view of the backlight chassis 60. Note that, in FIG. 3(b), the rear cabinet 40 and the battery 70 are also shown. Moreover, FIG. 4 is a simplified side view of the backlight chassis 60 and shows a state where the battery 70 and light source 80 are mounted. The backlight chassis 60 has a backlight arranging face 81 provided in the bottom on the rear face side and a battery arranging face 73 provided on the front face side.

To the backlight arranging face 81, an LED edge light in which a plurality of LEDs (Light Emitting Diodes) are arranged is attached as the light source 80.

To the battery arranging face 73, the battery 70 configured from nine cells 71 composed of three rows and three columns is attached. At the entire battery arranging face 73, a hole 72 which has substantially the same size as the battery 70 is formed. The battery 70 is covered with a black package so as not to penetrate light of the light source 80, and is mounted in close contact to the battery arranging face 73 so that light of the light source 80 does not leak from the hole 72 formed at the battery arranging face 73.

The battery arranging face 73 is provided on a face opposite to a face to which the light source 80 is attached in the backlight chassis 60 to reduce the effect by the heat of the light source 80. Therefore, the heat of the light source 80 attached to the backlight arranging face 81 is transferred to the backlight chassis 60 and is transmitted to the battery 70 attached to the battery arranging face 73. However, as the hole 72 is formed at the entire battery arranging face 73, the heat transmitted by the backlight chassis 60 is inhibited from being transferred by the hole 72 formed at the entire battery arranging face 73 and is difficult to be transmitted to the battery 70. Thus, according to the present embodiment, it is possible to reduce the effect that the heat of the light source 80 imposes on the battery 70 via the backlight chassis 60 and to prevent deterioration of the cells 71.

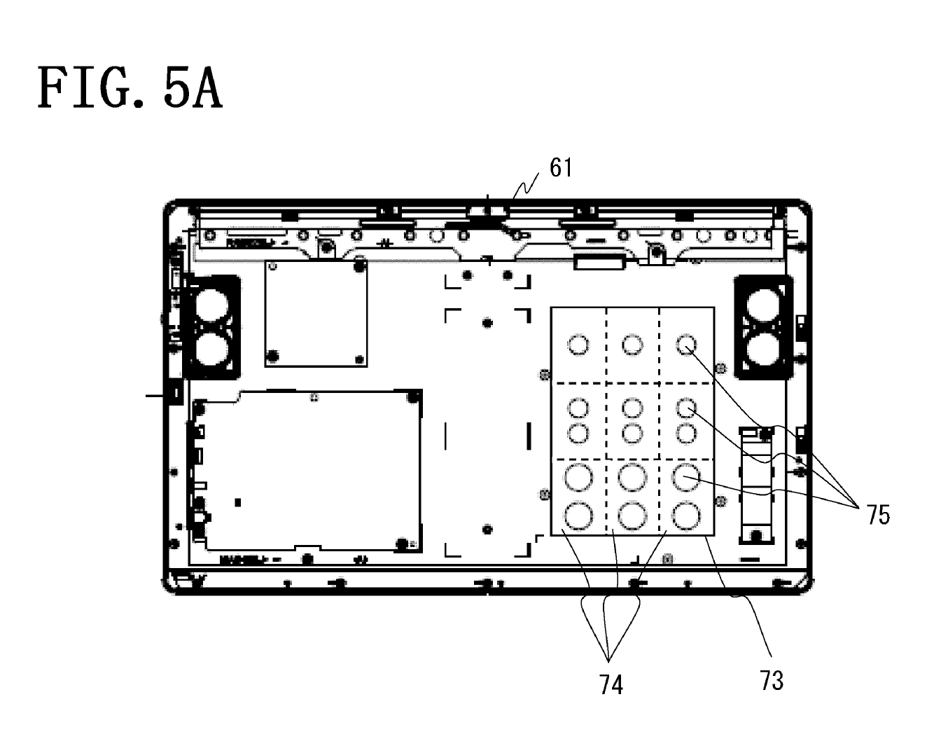

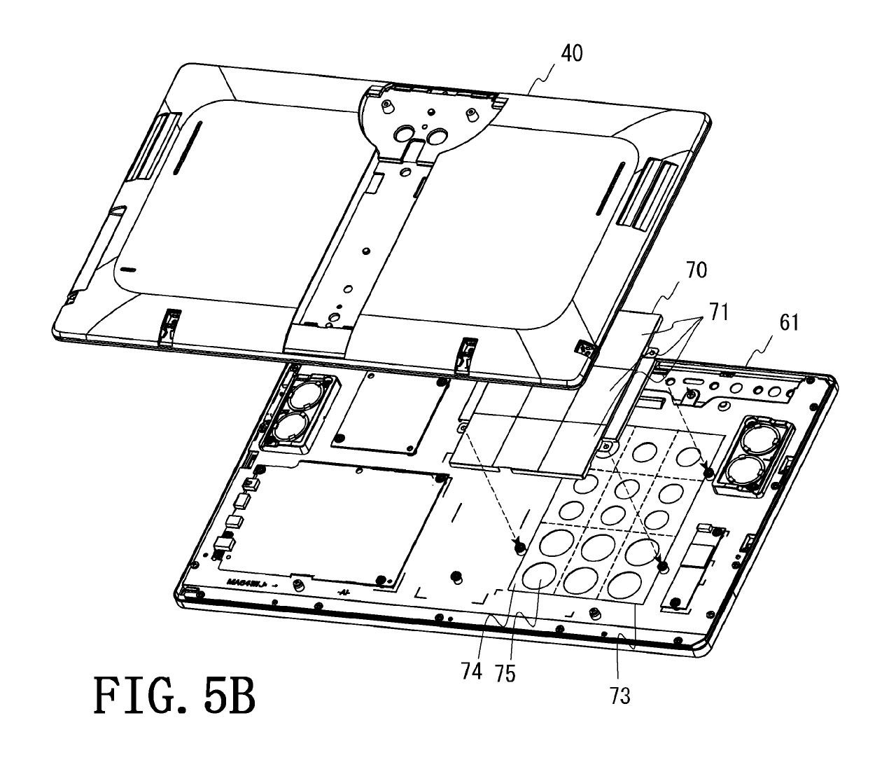

In the meantime, since an ambient temperature becomes higher as a distance is closer to the light source 80, even when the heat-insulating effect is improved by the hole 72 formed at the entire battery arranging face 73, there remains some fluctuations in temperature among the cells 71 depending on the arranging position of each cell 71. Thus, in a backlight chassis 61 shown in FIG. 5, the battery arranging face 73 is divided into faces corresponding to the respective cells 71 of the battery 70 (cell corresponding faces 74) to perform adjustment so that the heat-insulating effect by the hole 75 formed at each of the cell corresponding faces 74 is increased as a distance is closer to the light source 80. FIG. 5(a) is a front view of the backlight chassis 61, and FIG. 5(b) is a perspective view of the backlight chassis 61. Note that, in FIG. 5(b), the rear cabinet 40 and the battery 70 are also shown.

In the backlight chassis 61, the battery arranging face 73 is divided into nine cell corresponding faces 74 in three rows and three columns corresponding to the position of each cell 71 of the battery 70. Here, the cell corresponding faces 74 are arranged in parallel with the light source 80.

At each of the cell corresponding faces 74 in the first row that is the closest to the light source 80, two holes 75 which are the largest of the holes 75 formed at the cell corresponding faces 74 are formed. At each of the cell corresponding faces 74 in the second row that is the second closest to the light source 80, two holes 75 which are smaller than the holes 75 formed at the cell corresponding faces 74 in the first row are formed. At each of the cell corresponding faces 74 in the third row that is the third closest to the light source 80, one hole 75 which has the same size as the holes 75 formed in the second row is formed. That is, at each of the cell corresponding faces 74, depending on a distance from the light source 80, the larger hole 75 is formed as a distance is closer to the light source 80, thus making it possible to prevent the cells 71 closer to the light source 80 from deteriorating before the cells 71 away from the light source 80.

Hence, since the heat from the light source 80 is evenly transmitted to each of the cells 71 of the battery 70 via the backlight chassis 61, it is possible to make degree of deterioration even among the cells 71. Moreover, by forming the hole 75 at the cell corresponding face 74 corresponding to each of the cells 71, it is possible to increase strength of the backlight chassis 61 compared to the backlight chassis 60 in which the hole 72 is formed at the entire battery arranging face 73.

Note that, the hole 75 formed at the cell corresponding face 74 may be formed so that temperature of each of the cells 71 becomes even, and its shape, size and number may be changed as appropriate. For example, all the holes 75 formed at each of the cell corresponding faces 74 may be in the same chrysanthemum shape (the shape with teeth inside the hole 75) so that an opening area is able to be finely adjusted by folding or cutting petals of the chrysanthemum shape, to make temperature even among the cells 71. Note that, in the same manner, the hole 72 formed at the entire battery arranging face 73 may have teeth inside so that the opening area of the hole 72 is able to be finely adjusted.

The present invention is not limited to the embodiment described above and, needless to say, can be variously changed without departing from the intention of the present invention. For example, the number and arrangement of the cells constituting the battery 70 may be changed as appropriate. Moreover, the present embodiment may be applied to a liquid crystal monitor and a mobile terminal (a mobile phone or a tablet display device). Note that, same reference numerals are assigned to the component showing the same function in the embodiment described above.

### REFERENCE SIGNS LIST

10 liquid crystal television (liquid crystal display device)
20 frame
30 transparent protection cover
40 rear cabinet
50 sheet group
60, 61 backlight chassis
70 battery
71 cell
72, 75 hole
73 battery arranging face
74 cell corresponding face
80 light source
81 backlight arranging face

1. A liquid crystal display device, comprising:
a backlight chassis to which a light source is attached,
a battery arranging face provided on a face opposite to a face to which the light source of the backlight chassis is attached,
a hole formed at the battery arranging face, and
a battery attached to the battery arranging face.

2. The liquid crystal display device as defined in claim 1, wherein
the hole is formed corresponding to a cell constituting the battery.

3. The liquid crystal display device as defined in claim 2, wherein.
the hole is formed larger as a distance from the light source is closer.

4. The liquid crystal display device as defined in claims 1, wherein
the hole has a shape that enables to adjust an opening area.

5. The liquid crystal display device as defined in claims 1, wherein
the battery is covered with a black package and attached in close contact to the battery arranging face.
